(19) United States
(12) Patent Application Publication
(10) Pub. No.: US 2004/0181661 A1
(43) Pub. Date: Sep. 16, 2004

(54) Print processor and spooler based encryption

(75) Inventors: Andrew R. Ferlitsch, Tigard, OR (US); Roy Chrisop, Camas, WA (US); Daniel Leo Klave, Camas, WA (US)

Correspondence Address: Robert D. Varitz, ROBERT D. VARITZ, P.C., 2007 S.E. Grant Street, Portland, OR, 97214, US

(73) Assignee: Sharp Laboratories of America, Inc.

(21) Appl. No.: 10/389,650

(22) Filed: Mar. 13, 2003

(51) Int. Cl. G09C 5/00

(52) U.S. Cl. 713/153

(57) ABSTRACT

A system and a method for encrypting print job data. Encryption takes place in the data-communication region within a print job system which lies between a source for print job data, and the ultimate recipient thereof. Preferably, encryption takes place in a location of data de-spooling, such as in the vicinity of a print processor, a spooler, a print assist, or a port manager.

### BACKGROUND AND SUMMARY OF THE INVENTION

This invention pertains to apparatus and a method for encrypting the flow of print-data which is being conveyed in a printing system between a print-data source and a downstream print-data destination, or recipient. More specifically, the invention features implementing the method of such encryption by structure which is present in the mentioned communication path, and where such structure includes at least one of a spooler, a print processor, and a print assist. The recipient or “destination” for encrypted print data is preferably a printer, a server, or a fax device.

The present invention directs attention to the task of encrypting PDL print data flowing between the source for that data and the intended recipient destination. It thus addresses an issue not well handled by the current state of the art with respect to the exposure risks which attend the unsecured transmission of PDL data between source and destination.

Fundamentally proposed by the present invention is a system and a methodology which employ, within the communication path between a print-data source and a print-data destination, structure in the form either of a spooler and/or a print processor and/or print assist, and/or a port monitor to create an encrypted version of the data for secure transmission between that source and destination. The proposed encodation within this specified path is the central theme of the invention. Preferably, though not necessarily, data encryption takes place generally at the location of a print processor (such as a print processor in the Microsoft® Windows® operating systems) which lies in the mentioned communication path. Secondarily, it employs the usual spooler which also sits in that communication path to perform the task of data encryption. Thirdly, it may employ a print assist which sits in that same path, where a print assist is any component included in a print subsystem between, for example, a printer driver and a port manager. All of these approaches take place in a typical print-data communication system which may also include, within the communication path, a port manager. The various features and advantages of the invention will now become apparent as the description which follows is read in conjunction with the accompanying drawings.

### DESCRIPTION OF THE DRAWINGS

FIG. 1 is a block/schematic diagram illustrating both the preferred and best mode structure, as well as the preferred and best mode implementation of the methodology of, the present invention.

FIG. 2 is a block-form assembly figure describing how drawing FIGS. 10A and 10B, which set forth an algorithm that may be employed herein, should be juxtaposed for reading and reviewing purposes.

FIG. 3 is a block/schematic diagram illustrating an implementation of the present invention referred to as Encrypted Printing—Streaming PDL—Client Side Encryption.

FIG. 4 illustrates an implementation of the invention in a setting referred to as Encrypt PDL with PIN Printing.

FIG. 5 is a block/schematic view illustrating implementation of the invention in a manner referred to herein as Device Solution—Secured Remote (Peer-Peer) Printing.

FIG. 6 is somewhat similar in appearance in relation to FIG. 5, but here shows another implementation of the invention in a setting referred to as Device Solution—Secured Network (Print Server) Printing.

FIG. 7 shows still another implementation of the present invention in a setting referred to herein as Server Solution—Secured Network (Print Server) Printing.

FIG. 8 describes generally the PJL/PDL layout of a typical print data-stream.

FIG. 9 illustrates an encrypted layout generally of a typical print data-stream.

FIGS. 10A and 10B collectively, and when viewed as pictured in FIG. 2, describe what is referred to herein as non-encrypted algorithm for firmware interpreter.

FIG. 11 is another algorithmic drawing describing what is referred to herein as a decryption algorithm for firmware interpreter.

FIG. 12 is a block/schematic diagram illustrating implementation of the present invention in a setting referred to as Encrypted Printing—Streaming PDL—Device Side Decryption.

FIG. 13 is a block/schematic diagram illustrating an implementation setting referred to herein as Encrypted Printing—Streaming PDL—Server Side Decryption

### DETAILED DESCRIPTION OF THE INVENTION

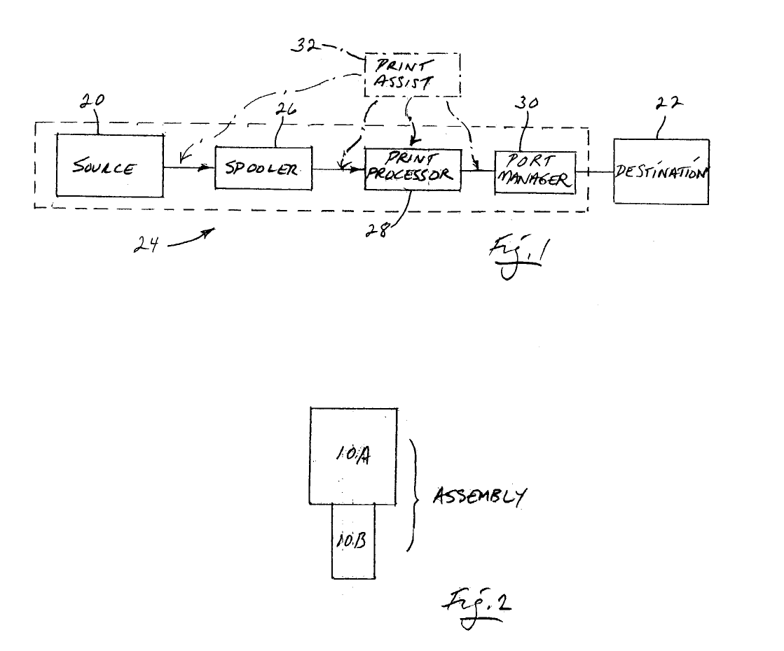

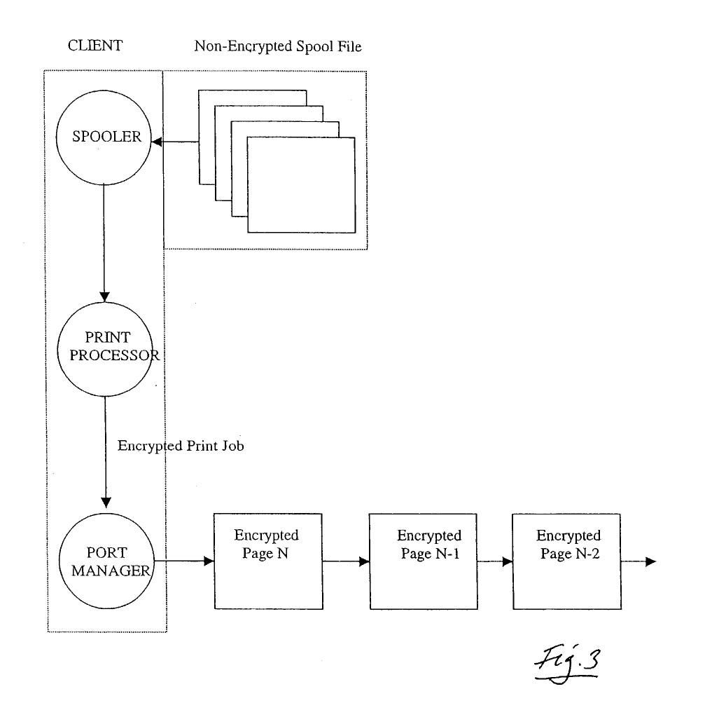

FIG. 1 in the drawings generally illustrates there a preferred embodiment of, and manner of practicing, the invention. Pictured in block form in FIG. 1 are a source 20 of print-job data, a final destination for that data, represented by a block 22 in FIG. 1, and intermediate the source and the destination, and generally pointed to by an arrow 24, a print-data communication path through which print data flows between the source and destination. Path 24 may typically include a spooler 26, a print processor 28, a port manager 30, and may additionally include, at a variety of different locations in and along path 24, a print assist which is represented in FIG. 1 by dash-dot block 32. “Destination” herein should be read to include a logical printer, or a logical fax device, which may include a printer, a fax device, an MFP device, a print/fax server, and/or a printer or fax pool.

Those who are skilled in the art will recognize from the block/schematic diagram of FIG. 1 just how a typical printing data system is constructed.

According to the invention, at any one of certain plural locations within and along path 24, print data (PDL) information is encrypted, utilizing any appropriate conventional encryption methodology. The several preferred sites, generally speaking, for performing such encryption include (a) the site of a print processor, such as print processor 28, secondarily, (b) the site of a spooler, such as spooler 26, and also (c) a port manager, such as port manager 30, and (d) a print assist, such as print assist 32 shown in FIG. 1. The exact algorithmic nature of encryption which is employed does not form any part of the present invention, and accordingly, is not detailed herein.

From the description just given regarding the contents of FIG. 1 in the drawings, those skilled in the art will recognize that they are fully armed to implement practice of the present invention, based upon various selectable printing system layouts, and employing conventional algorithms that can perform encryption. As has been mentioned, encryption can take place at various locations of choice, but generally in the region of a spooler and/or a print processor, for effecting print-data encryption. Notably, encryption takes place between source 20 and destination 22.

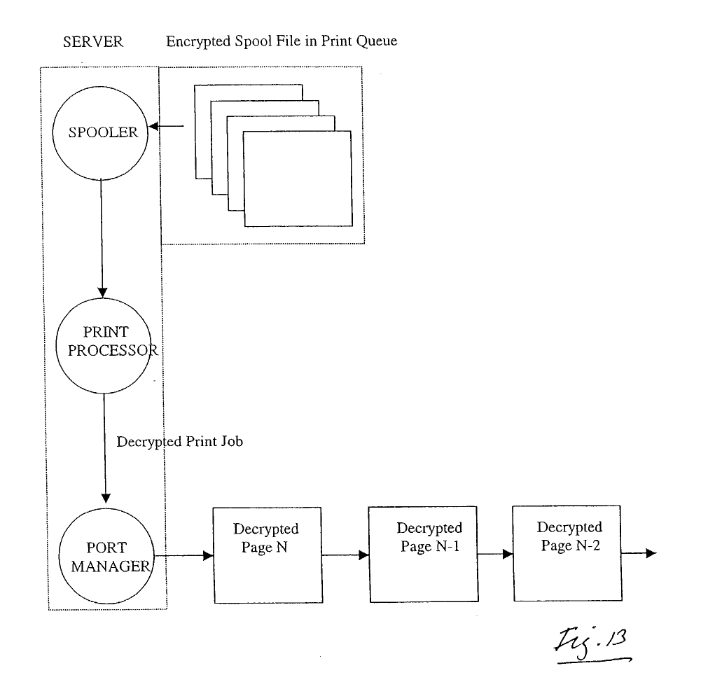

Various implementations (including some decryption approaches) are represented in drawing FIGS. 3-13, inclusive, herein are presented there in such a graphical fashion, and are labeled with sufficient information, also to equip those generally skilled in the relevant art to practice the invention, precisely in the respective manners that are shown in these drawing figures.

Accordingly, description of the invention now continues under side headings that relate directly to different selected ones of these other drawing figures which collectively illustrate a variety of ways in which practice of the invention may be implemented.

Print Processor or Spooler Encryption as Illustrated in FIGS. 3, 5 and 6

Here a print job is spooled to a spooler. The spooler despools the unencrypted print job to the print processor associated with the selected printing device(s).

The print processor optionally authenticates the user's access to printing the document(s) and/or to the printing device. The print processor then obtains the encryption key by any appropriate means and from any appropriate device, such as a key server, and partitions the print job into streaming segments, where a streaming segment is the smallest divisible unit of print data with respect to which a printer can start rasterization, and/or marking, without waiting for more print data. Typically streaming segments would include physical sheet boundaries, logical page boundaries and bands, including those that are linear, tiled, and object-related.

The print processor encrypts each streaming segment by any suitable means, and writes the encrypted print data to the port manager associated with the selected printing device(s).

In an alternate embodiment, a spooler, instead of a print processor, performs the above functions of authentication, partitioning the print data into streaming segments, and encrypting the streaming segments. Still other encrypting agencies may include a port manager or a suitable print assist.

The port manager then transmits the encrypted print job to the printing device, or to a server managing the printing device, or to a proxy acting on behalf of the printing device.

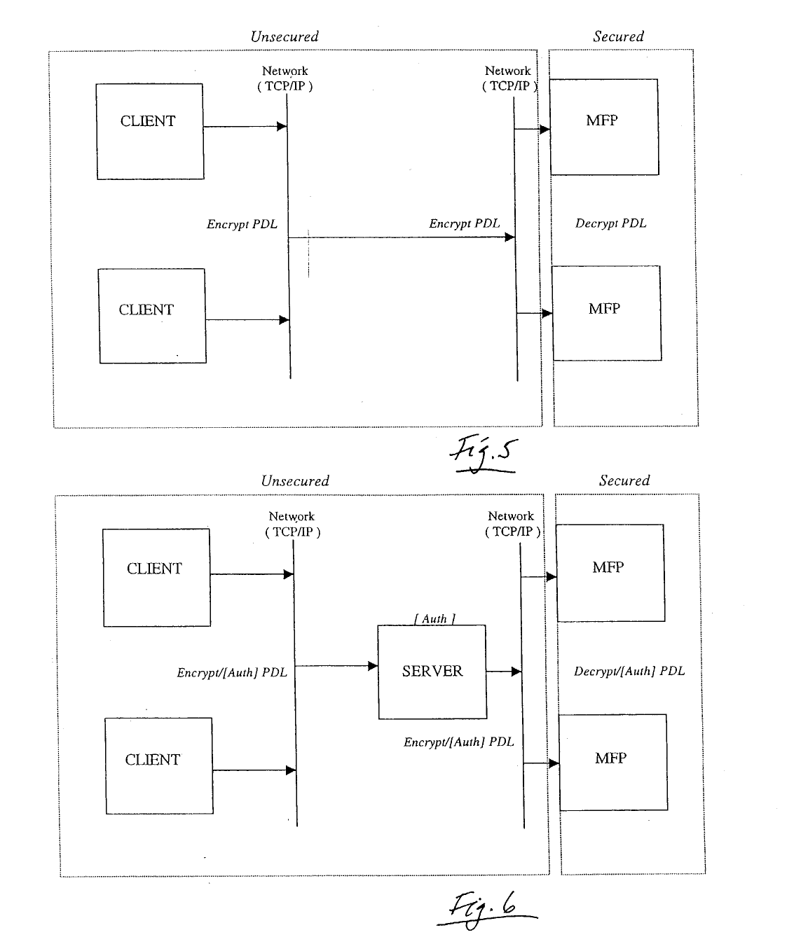

Encrypted Streaming PDL—Device Decryption as Reflected in Drawing FIGS. 5, 6 and 12

Here, the encrypted print job is decrypted by the printing device. The printing device may optionally authenticate the user's access to the printing device by any suitable means. The printing device may require authentication prior to despooling of the print data to the printing device. The printing device then obtains an appropriate decryption key by any suitable means.

The printing device then partitions the encrypted print job into streaming segments, wherein the boundaries of the streaming segments may be predetermined by embedded markings in the print job, or derived by a printer.

The process need not be serial. Decryption of the streaming segments, and rasterization/marking of the decrypted segments, may occur independently and in parallel.

The Illustrations of FIGS. 6, 8, 9, 10A, 10B, and 11

Here for performance purposes (e.g., speed and size), not all of a print job is required to be encrypted for secured printing. For example, the following non-page data print job components need not by encrypted, while the content of the print job is still secured:

1. Commands controlling the print job, such as PJL.

These commands typically describe the rendering method and assembly of the print job. These include, but are not limited to:

a. duplex printing

b. stapling and hole punch

c. n-up

d. resolution

e. paper size/stock

f. input/output trays

g. number of copies

2. Commands controlling the setting up a page. These include, but are not limited to:

a. Paper Size

b. Page Orientation

c. Margins

3. Font sets, such as True Type and downloaded fonts.

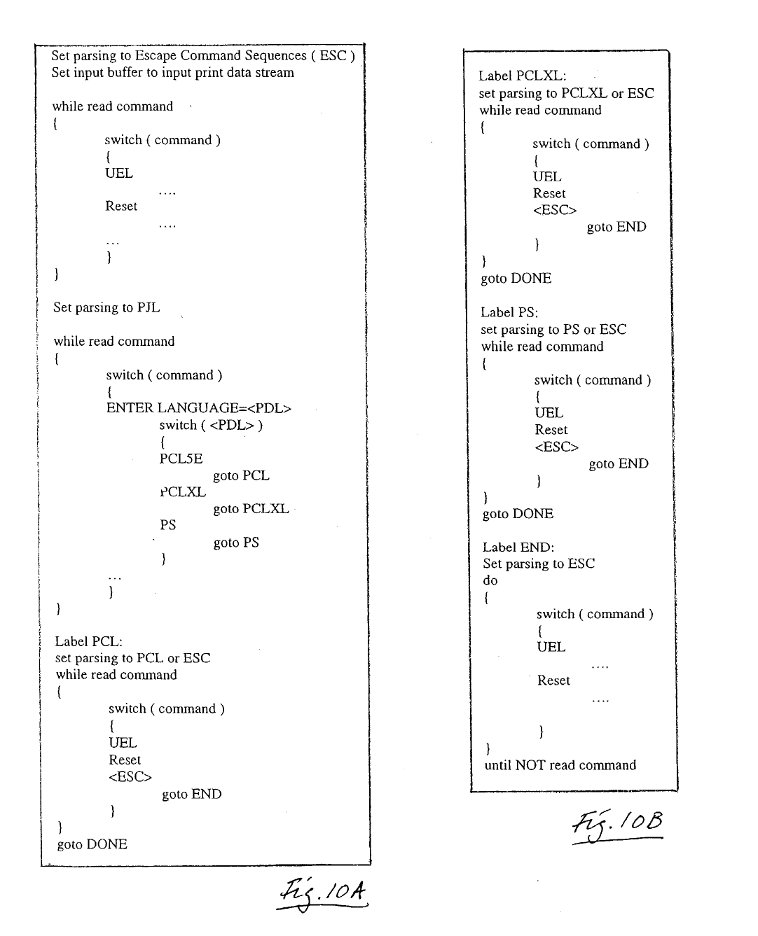

The boundaries of each encrypted streaming segment may be pre-marked on the encryption side. In this practice, partitioning into streaming segments is independent of the printer firmware. For example, in a typical non-encrypted print job, the print job consists of a PJL header sequence describing the assembly of the print job, followed by the print data for printing each page, followed by some end of job marker (see FIG. 8).

A client side encryption method could partition the print job into the PJL header, and one or more segments of print data, and then reassemble the print job as follows, but not limited to (see FIG. 9):

1. Unencrypted PJL header.

2. PJL commands to indicate encryption method.

3. PJL command indicating the start of an encrypted segment and optionally run-length.

4. Encrypted segment of print data.

5. Optionally a PJL command indicating the end of an encrypted segment.

6. PJL command indicating the start of another encrypted segment and optionally run-length.

7. Encryption segment of print data.

8. Unencryption End of Job marker

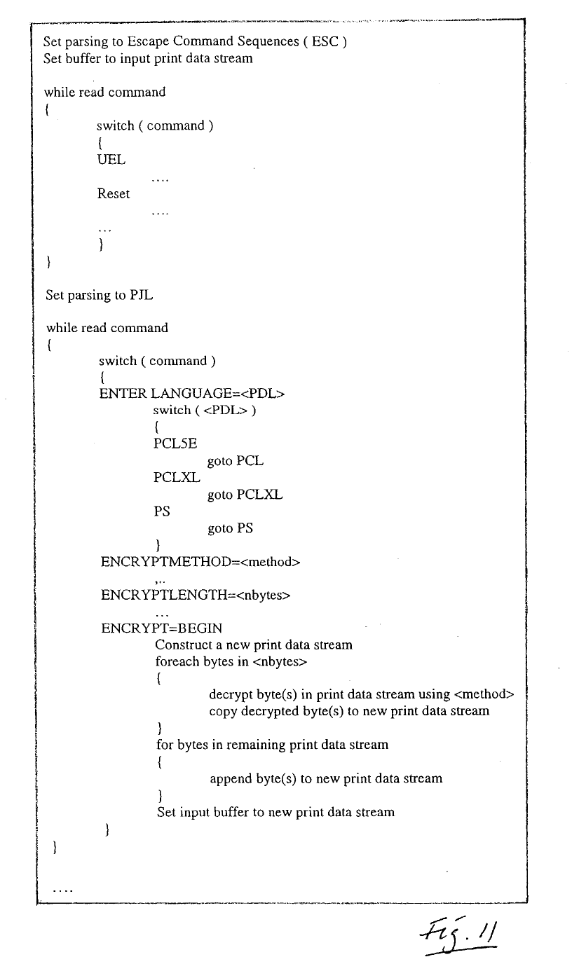

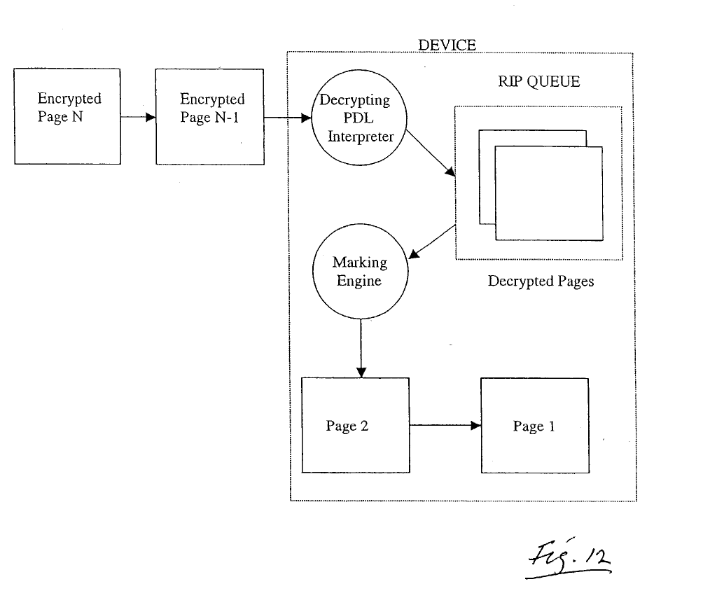

FIGS. 10A, 10B show pseudo code of a non-decrypting PDL interpreter in a typical printing device. The PDL interpreter generally supports several printer language modes. The interpreter generally works by parsing the current input data source according to the current printer language. As each command is parsed, the language parser passes the command to the language interpreter where the appropriate action is performed. Generally, the interpreter supports the ability to switch from one language to another in the same print job.

For example, as depicted in FIG. 9, a print job could start with a fixed sequence of universally known escape codes, such as the Universal Exit Language (UEL) and Printer Reset. When no more universally known escape codes are encountered, the parser switches to PJL as the default language mode. The print job is then followed by a sequence of PJL statements. The final PJL statement is a command to indicate the change of printer language (i.e., @PJL ENTER LANGUAGE=<. . . >). The parser would then change to the newly specified language mode.

FIG. 11 shows pseudo code for a decrypting PDL interpreter that would be compatible with the interpreter process described above for a typical printing device.

In this case, the PJL interpreter is extended to recognize new PJL statements for supporting encryption. One such statement indicates the start of an encrypted segment and the run length. In this case, when the encrypted segment marker is encountered, the interpreter passes the specified length of data to a unit for decryption. The input data buffer is then reset from the print data stream to the newly decrypted print data.

This method can be used to alternate back and forth from the print data-stream and the decrypted stream as the input buffer, and language mode changes can be independently embedded in the encrypted/decrypted stream.

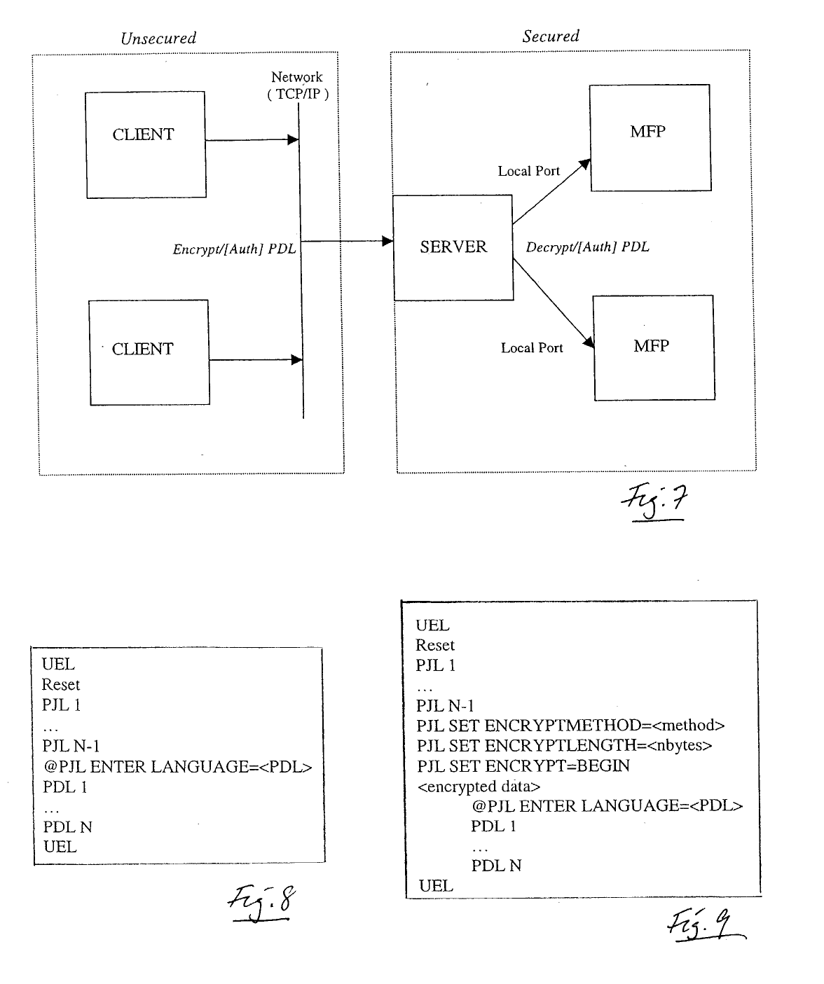

Encrypted Streaming of PDL—Server Decryption as Illustrated in FIGS. 7 and 13

In another embodiment, the encrypted print job is decrypted by a print server, where the client computing device despools the encrypted print job to a print server. The print job is then placed on a print queue on the print server, where the printer server's spooler will despool the print job from the server to the printing device.

In this embodiment, the print processor in the print server decrypts the print job prior to despooling to the printing device.

The print server's print processor optionally authenticates the user's access to the printing device. The print processor then obtains the encryption key by any suitable means.

The print server then partitions the encrypted print job into streaming segments, the boundaries of which may be predetermined by embedded markings in the print job, or derived by the print server. Each encrypted streaming segment of print data is then decrypted by the print processor and is passed on for rasterization and/or marking.

In an alternate embodiment, the spooler, the port manager, or the print assist, instead of the print processor, performs the above functions of authentification, partitioning the print data into streaming segments, and decrypting of the streaming segments.

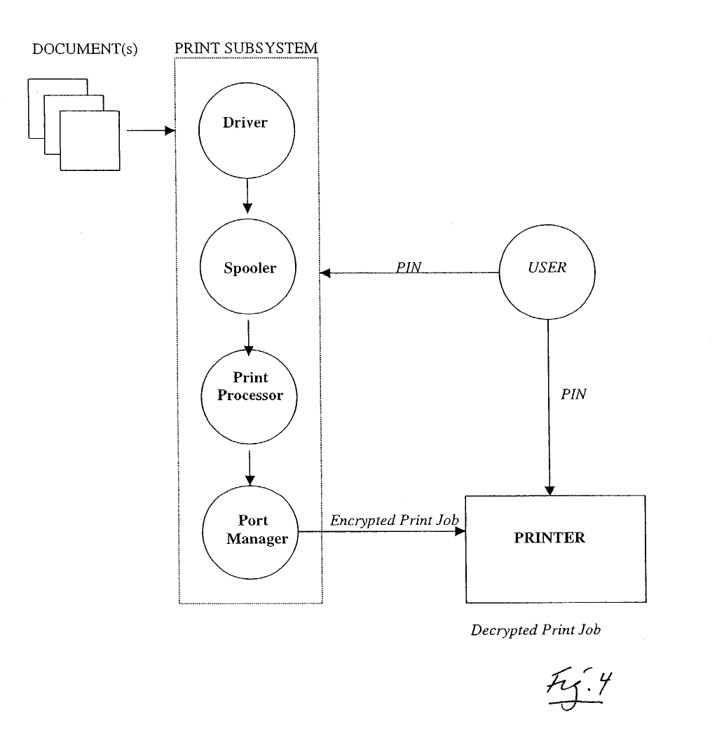

Embodiment Illustrated in FIG. 4

Here the PIN number entered by the user is used as the encryption key. A PIN, or confidential print job, is presumed not to be released from a spool queue, either on the client, the server, the printer or other location, until the user enters the PIN number (i.e., interactive printing).

The PIN number is then used to decrypt the print job. The print job would contain some unique signature that would be recognized if properly decrypted. If the user enters the wrong PIN number, the signature would not be detected, and the job would not be released for printing.

Thus there have been disclosed herein, preferred and best mode embodiments of, and preferred and best mode manners of implementing and practicing, the present invention. Encryption is performed in the related system region which lies between a source for a print job, and the destination for the job. Preferably, encryption takes place where de-spooling occurs in the vicinity of a print processor or a spooler. The features of the invention have been illustrated in a number of different variations, and included in the illustrations herein are further illustrations of how encrypted data, encrypted in accordance with practice of the present invention, can be decrypted. Accordingly, it is clear that a number of variations and modification may be made in the specific manner of invention implementation, and all of these are deemed to be within the scope of the invention.

We claim:

1. A computer-based print data system with print-data encryption comprising
print-data communication structure operatively interposed, and adapted to transfer and flow print data between a print-data source and a print-data recipient, and
disposed in said communication structure, intermediate said source and said recipient, structure constructed to perform print-data encryption.

2. The system of claim 1, wherein said structure which is constructed to perform print-data encryption take the form of at least one of (a) a spooler, (b) a print processor, (c) a port manager, and (d) a print assist.

3. The system of claim 1, wherein print data that is sourced for flowing in said communication structure toward said recipient is page-boundary characterizable, and said structure which is constructed to perform print-data encryption is specifically constructed to perform print-data encryption on any one of a page-boundary basis, a sheet-boundary basis, and a band-boundary basis.

4. The system of claim 1, wherein said recipient includes at least one of (a) a printer, and (b) a server.

5. A computer-based printing method offering print-data encryption comprising
conveying and flowing print data within a data-communication structure between a print-data source and a print-data recipient, and
at a selected location within such data-communication structure, and intermediate such a source and such a recipient, encrypting the mentioned print data.

6. The method of claim 5, wherein said encrypting is performed by at least one of (a) a spooler, (b) a print processor, (c) a print assist, and (d) a port manager.

7. The method of claim 5, wherein said encrypting is performed on any one of a page-boundary basis, a sheet-boundary basis, and a band-boundary basis.

8. The method of claim 5, wherein the print-data recipient to which encrypted print data flows is at least one of (a) a printer, and (b) a server.
